(19) United States
(12) Patent Application Publication
(10) Pub. No.: US 2025/0093047 A1
(43) Pub. Date: Mar. 20, 2025

(54) DISPLAY INTERFACE FOR INDUCTIVE COOKTOP SYSTEM

(71) Applicant: GHSP, Inc., Holland, MI (US)

(72) Inventors: Mark Glotzbach, Granger, IN (US); Cort Corwin, Grand Haven, MI (US); Marc Smeyers, Zeeland, MI (US); Benjamin Moes, Caledonia, MI (US)

(73) Assignee: GHSP, Inc., Holland, MI (US)

(21) Appl. No.: 18/580,845

(22) PCT Filed: Jul. 21, 2022
(86) PCT No.: PCT/US2022/074013

§ 371 Date: Jan. 19, 2024

Related U.S. Application Data
(60) Provisional application No. 63/224,174, filed on Jul. 21, 2021.

(51) Int. Cl. F24C 7/08; H05B 6/06

(52) U.S. Cl. CPC F24C 7/086; F24C 7/083; H05B 6/062; H05B 2213/05

(57) ABSTRACT

An inductive cooktop system includes a top plate for supporting a cookware object and a display disposed vertically below the top plate. A sensor array is disposed between the top plate and the display. An induction coil is disposed vertically below the display, where the induction coil is operable to generate a magnetic field extending above the top plate. A control system receives an input indicating a location of the cookware object on the top plate and determines a first set of pixels of the display corresponding to the location of the cookware. A burner graphic is displayed at a periphery of the first set of pixels at the indicated location for the cookware object. A second set of pixels are identified that are sized to display a control graphic outside of the burner graphic.

### STATEMENT OF RELATED CASES

This application claims priority to U.S. Provisional Patent Application Ser. No. 63/224,174, filed on Jul. 21, 2021 and entitled Display Interface For Inductive Cooktop System, the entirety of which are herein incorporated by reference.

### TECHNICAL FIELD

The present disclosure relates to an appliance display interface, and more particularly to a display interface for an inductive cooktop system.

### BACKGROUND

Kitchens or other areas used to prepare and cook food may have an inductive cooktop, such as a cooktop that is part of a range unit or a separate cooktop unit that is placed on or installed directly in a countertop or other work surface. It is common for inductive cooktops to have a top ceramic panel that supports cookware during use and an induction coil below the ceramic panel that inductively heats the cookware. The induction coil is typically operated with a control interface that is in front of the ceramic panel at the front edge of the cooktop appliance. This control interface may display information to the user on a relatively small display screen located away from the actual cooking surface.

### SUMMARY

According to one aspect of the present disclosure, an inductive cooktop system includes a top plate comprising a top surface for supporting a cookware object and a display disposed vertically below the top plate. A sensor array is disposed between the top plate and the display. An induction coil is disposed vertically below the display, where the induction coil is operable to generate a magnetic field extending above the top surface of the top plate. A control system is configured to receive a cookware location input indicating a location of the cookware object on the top surface of the top plate and determine a first set of pixels of the display corresponding to the indicated location from the cookware location input. A second set of pixels of the display are identified separate from the first set of pixels sized to display a control graphic. A burner graphic is displayed at a periphery of the first set of pixels at the indicated location for the cookware object. A control graphic is displayed at the second set of pixels.

Implementations of the disclosure may include one or more of the following optional features. In some implementations, the sensor array and/or the induction coil are used to provide the cookware location input. In some examples, the sensor array is used to provide the cookware location input, and the cookware location input may include a cookware identification. For instance, the cookware identification may include a cookware size based on the sensed periphery of the cookware object or an identifier based on a sensed bottom surface feature.

In some examples, the sensor array is configured receive touch inputs at the displayed control graphic. The displayed burner graphic, in some implementations, extends a threshold distance outward from a sensed edge of the cookware object. In some examples, the displayed control graphic is outside of the displayed burner graphic. Further, in some examples, the control system is configured to perform a graphic location process when multiple objects are placed on the top surface to display the burner graphic at sensed cookware objects and to display the control graphic at other locations on the display that are accessible to view and touch and free of objects placed on the top surface.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of a countertop with an inductive cooktop.

FIG. 2 is a schematic cross-sectional view of an inductive cooktop.

FIG. 3 is a schematic side view of an inductive cooktop.

FIG. 4A is a schematic side view of an inductive cooktop, showing the ceramic cover raised away from a sensor array.

FIG. 4B is a schematic side view of the inductive cooktop shown in FIG. 3A, showing the ceramic cover and the electronics unit removed.

FIG. 5 is a schematic top view of an inductive cooktop, showing sensors at locations around a perimeter of the cooktop.

FIG. 6A is a bottom view of a pan used on the induction cooktop.

FIG. 6B is a perspective view of a section of the bottom of the pan, taken at section B shown in FIG. 6A, showing pads applied to the bottom surface.

FIGS. 7-9 are bottom views of pans having different pads applied to the bottom surfaces thereof.

FIG. 10 is an upper perspective view of a control knob.

FIG. 11 is a bottom view of a control knob.

FIG. 12 is a schematic top view of an inductive cooktop, showing displayed images around portion of the cookware.

FIG. 13 is a schematic top view of an inductive cooktop, showing virtual boundaries around the cookware.

FIG. 13 is a schematic top view of an inductive cooktop, showing virtual boundaries around the cookware.

FIGS. 14-16 are schematic top views of an inductive cooktop, showing different placement locations of the cookware and resulting display locations for corresponding graphical control images.

FIGS. 17A-17B are schematic top views of an inductive cooktop, showing graphical control images displayed at locations corresponding to the cookware location.

FIG. 17C is a flow chart of a process for displaying graphical control images relative to sensed pan locations on the inductive cooktop.

FIG. 18 is a schematic top view of an inductive cooktop, showing graphical control images displayed in a layered configuration.

FIG. 19 is a schematic top view of an inductive cooktop, showing a control knob and a graphical representation displayed next to the control knob.

FIG. 20 is a schematic top view of an inductive cooktop, showing graphical control images displayed in a layered configuration and a control knob located off the display surface of the cooktop.

FIG. 21 is a schematic top view of an inductive cooktop, showing multiple control knobs located in front of the display surface of the cooktop.

FIG. 22 is a schematic top view of an inductive cooktop, showing a large portion of the cooktop used to display graphical content independent of the cookware items.

FIG. 23 is a schematic top view of an inductive cooktop, showing a large portion of the cooktop used to display graphical content related to the cookware items.

FIG. 24 is a schematic top view of an inductive cooktop, showing multiple non-cookware objects placed on the top surface of the cooktop.

FIG. 25 is a schematic top view of an inductive cooktop, showing graphical control images displayed in non-overlapping locations in response to non-cookware objects placed on the top surface of the cooktop.

FIG. 26 is a schematic view of an example computing device that may be used to implement the systems and methods described herein.

Like reference symbols in the various drawings indicate like elements. Reference numbers incremented by 100 also indicate like elements, unless specified to the contrary.

### DETAILED DESCRIPTION

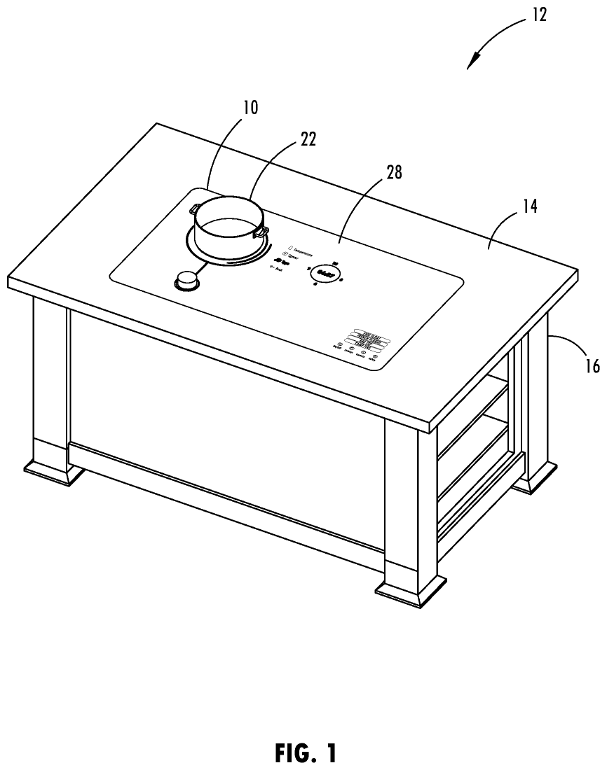

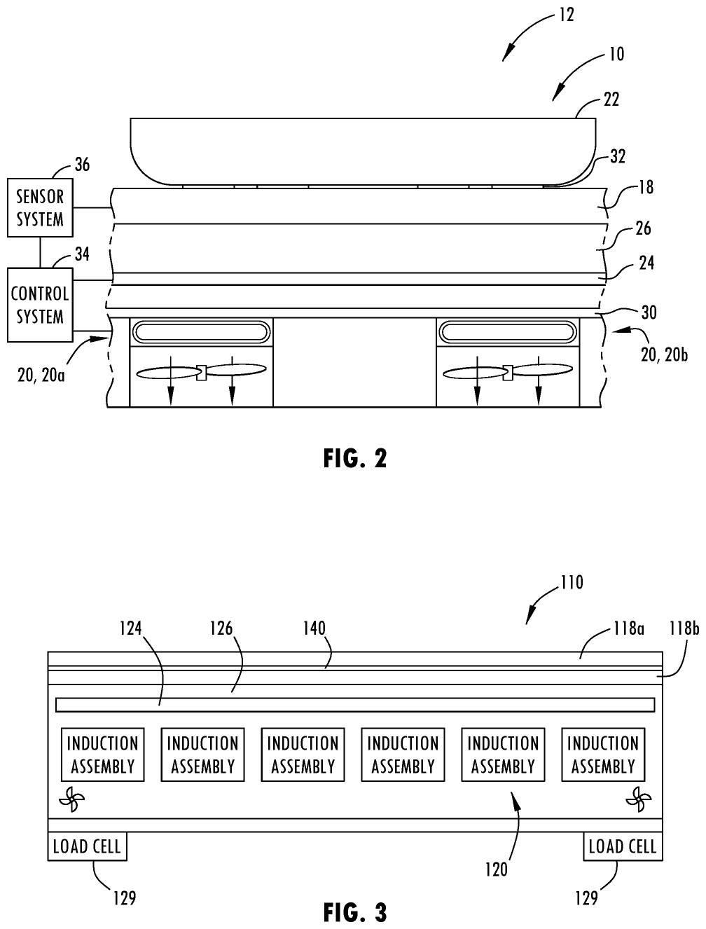

Referring to FIG. 1, in some implementations, an inductive cooktop system 10 is provided in a kitchen environment 12 or other area used to prepare and cook food. For example, FIG. 1 illustrates the inductive cooktop system 10 installed in a countertop 14 of a cabinet 16 within the kitchen environment (e.g., a kitchen island). The inductive cooktop system 10 may include a display element (e.g., shown as display panel 24 in FIG. 2) that operates to emit light and illuminate a display area extending across the cooktop surface 28. This display element may display various graphics to the user or others in the environment, such as user interface graphics or media content or the like. As also shown in FIG. 2, the inductive cooktop system 10 includes a top plate 18 (e.g., a transparent glass and/or ceramic panel) disposed over the display element and an induction coil 20 (e.g., a solenoid coil) that is disposed below the top plate 18 and the display element. The top plate 18 defines the cooktop surface where a cookware item is placed for cooking. Here, the display panel 24 is an organic light emitting diode (OLED) display panel that emits light using one or more OLEDs. In additional examples, the display panel may be a thin-film-transistor liquid-crystal display (TFT LCD) panel, a light-emitting diode display (LED) panel, a plasma display panel (PDP), a liquid-crystal display (LCD) display panel, a quantum dot display (QLED) panel, or an electroluminescent display (ELD) panel or the like.

A power supply (not shown) may supply alternating current, such as high-frequency or medium-frequency current, to the induction coil 20 to create an electromagnetic field that can inductively couple with and heat a cookware object 22 (e.g., a pan, pot, or the like) supported on an upper surface of the top plate 18. The electromagnetic field may permeate through the upper surface of the top plate 18 in the area immediately above the induction coil 20. The electromagnetic field oscillates to create eddy currents in or near the bottom portion of the cookware object 22 that is supported on the top plate 18, such that the resistance of the cookware object 22 to the eddy currents causes resistive heating of the cookware object 22. Thus, the inductively heated cookware object 22 may heat and cook the contents within the cookware object 22. To adjust cooking temperature, the power (e.g., via the current) supplied to the induction coil 20 may be adjusted.

The cookware object 22 may include a ferrous metal, such as at least at a base of the cookware object 22, to be capable of inductively coupling with the induction coil 20 and conductively spreading the heat to the cooking surface within the cookware object 22. Also, the cookware object 22 may include various types of cooking vessels, such as a pot, a pan, an induction plate, a wok, and the like. It is also contemplated that the cookware object 22 may be product packaging, such as a metal food packaging that is configured to be used without an underlying piece of cookware. Further, it is contemplated that the cookware object 22 may be an electrical device that is configured to inductively couple with the induction coil 20 to transfer data or power via the inductive coupling. Such an electrical device may include a small kitchen appliance, such as a toaster or blender, a receptacle unit for plugging in other devices powered via electrical wires, or other personal electronic devices, such as cell phones.

The induction coil 20 may refer to a solenoid coil of various shapes or configurations ranging from a C-shaped coil where each end of the “C” is adjacent to the top plate 18 to a more traditional pancake coil. The induction coil 20 may refer to a single coil or a plurality of coils (e.g., an array of coils) below the top plate 18. In some configurations, the configuration and/or construction of the coils 20 may aid in mitigating coupling effects on the display element of the alternating magnetic field generated by the coil 20. By properly orientating the c-shaped solenoid coil with the display element (e.g., the display panel 24), metal or conductive lines in the display (e.g., the backplane of the display), which may be most vulnerable to electrical interference, are aligned parallel or generally parallel to the magnetic field lines or flux. Additionally or alternatively, metal or conductive lines in the display (e.g., the backplane of the display) that are identified as less vulnerable or least vulnerable to electrical interference may be aligned orthogonal to the magnetic field lines.

In some examples, the top plate 18 or a layer thereof may include a semi-transparent or light reducing effect, such as a tinted glass or film applied to the glass to reduce the light transmission without generally affecting the optical clarity. This can be referred to as providing a dead-front look to the top plate ceramic, such that the cooktop surface appears to be black when the display is off and the display is configured to transmit light with enough intensity to be visible through the darkened top plate. Such darkened appearance may also reduce the appearance of potential artifacts in the display that in some instances may be created by the operation of the induction coils. Also or in the alternative, an anti-glare or anti-reflection film or coating may be applied to the top plate to provide a more desirable appearance during use and when acting as a dead front to the cooktop.

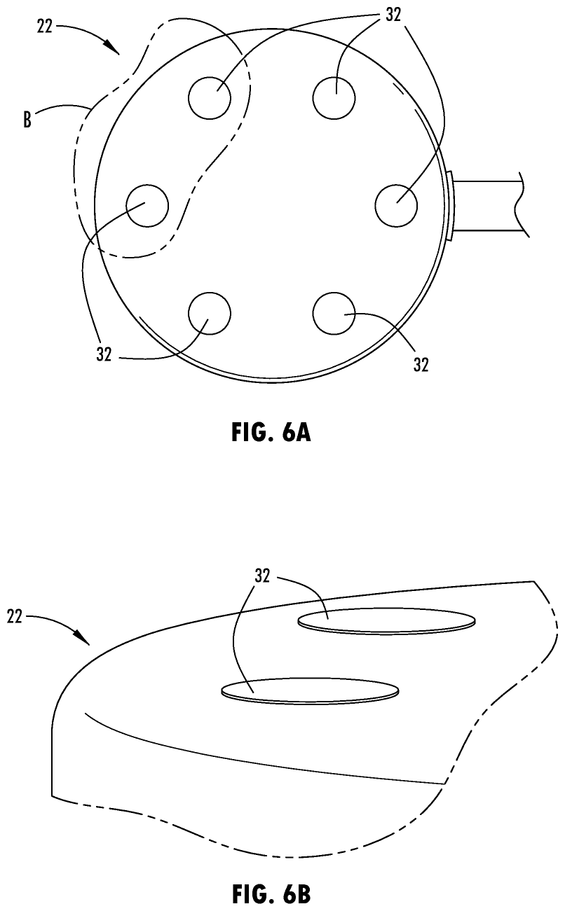

As further shown in FIG. 2, in some examples, the inductive cooktop system 10 includes one or more heat dissipation layers 26 (e.g., a thermal insulating material or an air gap) between the cover or top plate 18 and the display panel 24. The dissipation layer 26 may act as a thermal insulator such that heat generated at the cooktop surface 28 (e.g., via the cookware object 22) may be dissipated during operation of the cooktop system 10 and help prevent malfunction and/or failure of the display panel 24. The dissipation layer 26 may also have transparent properties (e.g., optical clarity) to prevent blurring or otherwise distorting the image quality of the display 24 when the dissipation layer 26 is beneath the cooktop surface 28. Also, a heat dissipation layer 30 (e.g., thermal insulating material or air gap) may be provided between the display panel 24 and the coils 20 or between the cookware object 22 and the cooktop surface 28 (e.g., pads 32 disposed at the bottom of the cookware that form an air gap between the bottom surface of the cookware and the cooktop surface, as illustrated in FIGS. 6A, 6B). In the example of a gap filled with air or fluid, the air or fluid may be circulated to assist with heat dissipation. The desired thickness of the dissipation layers may depend upon the type(s) and/or density of insulation used in the space and the desired thickness may be configured to provide sufficient cooling benefits for maintaining longevity of the electrical components (e.g., the display panel 24) during operation of the cooktop system and without impeding inductive coupling.

As shown in FIG. 2, in some examples, the inductive cooktop 10 includes a control system 34, such as control system circuitry, that is configured to detect or to receive inputs from a sensor system 36 and to perform processing tasks related to those inputs. In some configurations, the control system 34 is coupled to or in communication with the coil layer 20, the display 24, and/or the sensor system 36. For instance, the control system 34 may be physically wired to interfaces of these elements or may communicate wirelessly with these elements. In some configurations, the control system 34 includes more than one controller in electronic communication with each other controller, directly or indirectly. Here, each controller may operate individually or communicate with each other to control some portion of the system 10. For instance, each of the display 24, the coil layer 20, and/or the sensor system 36 may include its own component controller(s) that collectively form the control system 34. For example, different types of controllers may be used throughout the system 10 depending on the communication protocols implemented or the type of information/data that is being communicated. In a further alternative, each component controller may communicate with a central controller, the collection of component controllers and central controller collectively comprise the control system 34.

With respect to operation of the display panel 24, the control system 34 is configured to control the display panel 24, such as to generate and display information at the cooktop surface 28, including at a cooking area or areas of the upper surface that interfaces with a cookware object 22 that is inductively coupled with an induction coil 20. The control system 34 may generate and control information displayed by the display panel 24 before, during, or after operation of the induction coil 20 inductively coupling with a cookware object 22. As further described herein, some examples of information displayed by the display panel 24 include operational information of the cooktop, outlines of cooking zones or control interfaces, control interface images, media widows or information, or branding or advertising windows or information and other conceivable images and graphics.

In addition to controlling the display 24, the control system 34 is configured to control the coil layer 20 (e.g., a single coil or an array of coils). Here, the control system 34 may supply power (e.g., in the form of voltage or current) to one or more coils (e.g., coils 20a, 20b) of the coil layer 20 to activate, deactivate, or adjust the operational characteristics of the coil 20 (e.g., adjust the inductive heating power of one or more coils 20). The control system 34 may also receive signals from the coil layer 20 indicating the resistance at a coil, which can indicate the presence of and type of object on the cooktop surface.

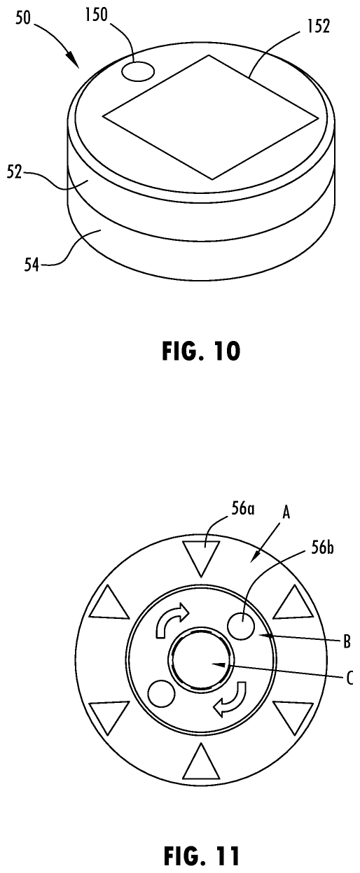

Generally speaking, a sensor system 36 may be configured to receive or to detect a variety inputs associated with the cooktop system 10 and to communicate these inputs to the control system 34 in order to control elements, such as the display 24 and/or the coil layer 20. Although the inputs are described as detected by the sensor system 36, the control system 34, the display 24, and/or the coil layer 20 may be configured to receive/detect these inputs directly or independently of a sensor system 36. Alternatively, the control system 34, the display 24, and/or the coil layer 20 may constitute component elements of the sensor system 36. Some of these inputs include direct inputs from the user, such as touch inputs or other contact based inputs, or indirect inputs from the user, such as inputs channeled and/or communicated by an object associated with the user. For instance, the sensor system 36 is configured to receive inputs from peripherals associated with the display 24 and/or system 10, such as a keyboard, a mouse, a stylus, a remote control (e.g., the knob of FIG. 10), microphone, camera, image scanner, etc. These peripherals may use wired or wireless protocols (e.g., Bluetooth, near-field communication, radio frequencies (RF) such as RFID, WiFi, etc.), directly or indirectly through one or more gateway devices, such as a router, hub, etc. In some examples, the sensor system 36 receives indirect inputs from sensors that identify a presence of an object (e.g., a cookware object 22) on the cooktop surface 28 or adjacent to the cooktop surface 28 (e.g., in a range of the sensor system 36 within a spatial area about the cooktop surface 28) or characteristics associated with such an object (e.g., temperature, position, orientation, etc.).

In some examples, the display 24 (e.g., via the control system 34) is configured to receive inputs from interaction with the cooktop system 10. For instance, the display 24 may receive inputs corresponding to interaction at the cooktop surface 28 of the cooktop system 10 by a user of the system 10 or from an object associated with the user. Based on these inputs, the display 24 (e.g., via the control system 34) is configured to generate content or content information and to display the generated content or information on the display 24 for the user to view at the cooktop surface 28. In other words, the display 24 may function as a user interface that generates content, modifies content, or removes content in the form of images, multimedia, indicators, or the like.

As shown in FIG. 3, an example assembly construction of a cooktop system 110 is provided that has sensor system 36 including a sensor array 140 located between two layers of transparent or semi-transparent material (e.g., ceramic plates 118a, 118b) that are designed to support cookware. The top and bottom plates 118a, 118b may be the same or different materials or thicknesses. The top plate 118a may include surface treatments or coatings to improve scratch resistance or aid in cleaning. The bottom plate 118b may be a support plate providing greater structural support to the cooktop 110. The sensor array 140 may be made with Indium tin oxide (ITO) or a poly(3,4-ethylenedioxythiophene) (PEDOT) material. In some examples, the sensor array 140 may be a touch sensor array, such as a frequency response touch sensor. In some examples, the sensor array 140 may be or include a temperature sensor or array of temperature sensors. Thus, the sensor array 140 may be referred to as a frequency response touch sensor, which includes capacitive sensors, resistive sensors, surface acoustic wave (SAW) pressure sensors, infra-red (IR) sensors, and the like. An air gap 126 is located between the display 124 and the bottom transparent material 118b, where air is circulated to keep the display 124 at a temperature below its maximum operating temperature. The sensor array 140 may be located between the layers of the transparent or semi-transparent materials, such as to prevent the circulating air from cooling the sensor array 140, which allows the sensor array 140 to measure a more accurate temperature of the transparent or semi-transparent material, thereby providing a more accurate estimation of the surface temperature of the cooktop surface 128. The electronics unit 120 may by a sealed assembly housing the display, the induction layer comprising an array of induction coils, and the control system. The sealed electronics unit may include or be in contact with a heatsink or heat exchanger to reduce heat exposure to the display and control system electronics. In addition, a load cell 129 or other weight or force measurement sensors, including where the load cell 129 comprises an array of load cells or weight or force measurement sensors, may be located under the assembly to measure weight of the cooktop and any objects placed onto the cooktop. By subtracting the known weight of the cooktop assembly from the weight measurement, the system can determine the total weight of objects placed onto the cooktop. By measuring changes over time, the system may determine the weight of individual objects when multiple objects are present.

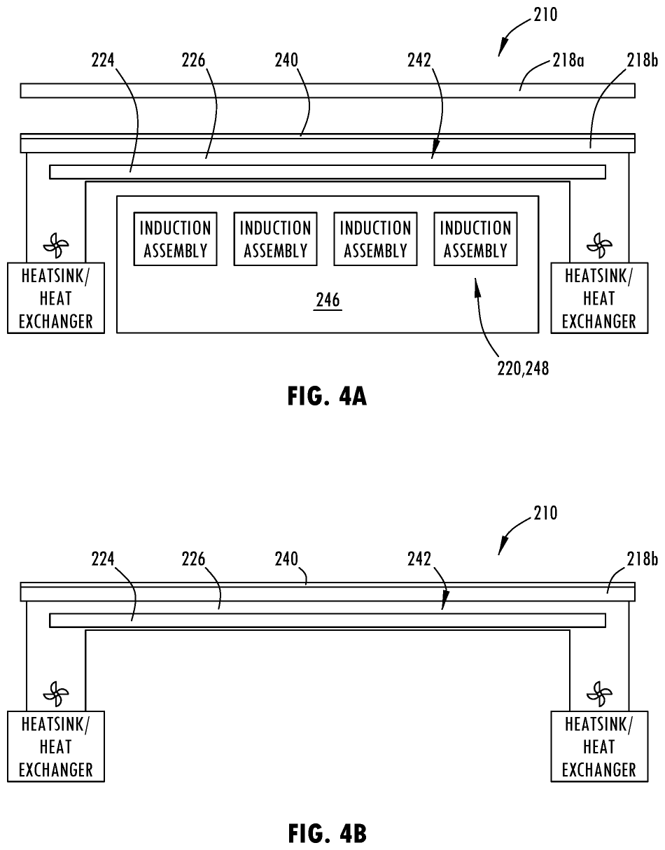

As shown in FIG. 4A, an example assembly construction of a cooktop system 210 has two layers of transparent or semi-transparent material (e.g., ceramic plates 218a, 218b) that are separable, such as to allow the cover layer to be replaceable and the sensor array 240 to be accessed for repair or replacement. The display 224, bottom transparent material 218b, and sensor array 240 are constructed together in a single unit as a sealed display unit 241. For example, as shown in FIG. 4B, the sealed display unit 241 is removed from the electronics unit and the cover (e.g., the ceramic plate 218a) is removed from the sensor array 240. This sealed air chamber 242 prevents dust and other foreign materials from becoming deposited on top of the display 224, negatively impacting the visual performance of the system 210. In addition, this allows the sealed display unit 241 housing the display 224 and sealed air chamber 242 to be replaceable separate from the top cover 218a and the other electronics, such as the electronics unit 246 that is shown containing the induction assemblies 248.

The sealed display unit 241 has a sealed heat dissipation layer, such as sealed air chamber 242 with a heat exchanger 244 to allow heat to be removed from the sealed air chamber 242. The sealed air chamber 242 may be formed with the transparent top material 218b, display 224, and additional solid materials or it may be built from a transparent material that enclose all the components including the transparent material 218b and display 224. The sealed air chamber 242 may use circulating air, gas, or a liquid that has an optical index of refraction similar to air or to the glass/transparent materials present in the system 210. In this specification, the phrase an optical index of refraction similar to air or to the glass/transparent materials means that the graphics generated at the display 224 remain readable and without distortion from outside the sealed display unit. The heat exchanger 244 may use a secondary air or liquid coolant to remove heat, or it may be a heatsink that allows the transferred heat to be removed from the sealed chamber through convection and conduction to the ambient environment. An internal fan or pump may be arranged to circulate the internal air or liquid coolant within the sealed display unit 241. An external fan (not shown) may be arranged to circulate external air over the heatsink. A weight measurement sensor may be incorporated under the assembly as shown in FIG. 3 or it may be incorporated in the sensor array between the layers of cover glass/ceramic 218a and the structure below, including for example, sensor array 240.

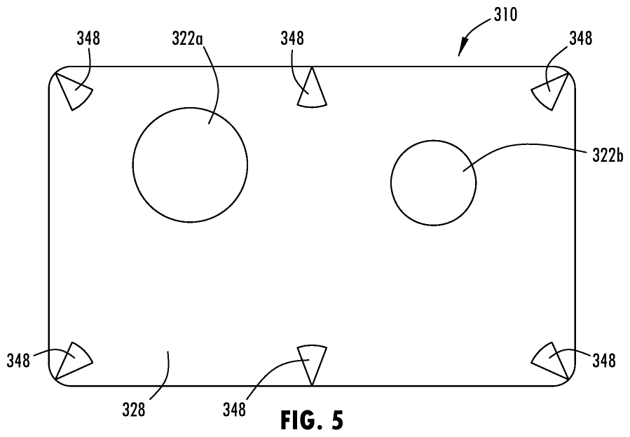

As shown in FIG. 5, the cooktop system 310 may use a series of sensors 348 located around the perimeter of the cooktop surface 328. The sensors 348 are able to measure distance to an object (e.g., cookware objects 322a, 322b) in the line-of-sight of the sensor. For example the sensors 348 may be horizontal infra-red, which may also or alternatively measure the object temperature. The sensors, in some examples, may be LIDAR sensor or mm-wave radar sensors or other applicable sensor technologies or combinations thereof. In addition, these sensors may be a solid-state array of sensors, may use a rotating sensor, or may use a grid of sensors. Each sensor may measure distance and temperature. Alternatively, a separate array of distance and temperature sensing may be used. This array can be used to detect the presence and distance of objects placed onto the cooktop. When distance information from multiple sensors in the array is combined, the location and size of the object touching the display may be determined. This may be a piece of cookware with a large diameter intersecting the line-of-sight with many infra-red sensors, or may be a finger being used to touch the control surface wherein only two sensors may detect the presence of the finger. In addition, if the array of infra-red sensors is able to measure temperature, this system may be used to control the heating cycle of the cooktop including temperature control and feedback of cookware, safety limits such as empty cookware being heated, and the presence and characteristics of non-induction heatable objects such as glass or aluminum cookware the may leave the surface hot when removed.

In some examples, the induction cooktop system has a display that is used between the induction heating coils and the top surface of the cooktop. A touch control panel may used in conjunction with the display to enhance control and usability of the cooktop. In some instances, the display covers the entire set of induction coils and incorporates touch controls over the entire display portion of the cooktop. By incorporating touch controls to the entire cooktop, the entire cooking surface becomes more flexible by allowing graphics and controls to be used anywhere on the cooktop. The frequency response touch sensors may include capacitive sensors, resistive sensors, surface acoustic wave (SAW) pressure sensors, infra-red (IR) sensors, and the like. For example, the touch controls may use a frequency response touch system where transparent or near-transparent conductors are used in an array to detect the presence of a material with a relative permittivity different than air. This array of conductors is generally located between the display and the top surface. In another example, the cooktop may use a touch sensor array located on top of the main cooking surface as a thin layer. In yet another example, this touch control system may use surface acoustic wave (SAW) that incorporates ultrasonic sound wave transducers and sensors into the construction of the top surface. In a further example, the display and/or touch controls may cover or overlap only a portion of the area that includes the induction heating coils.

By using touch controls that cover only a portion of the induction cooktop, the system may prevent the user from having to touch areas of the cooktop surface where a piece of cookware may have been placed or nearby to where piece of cookware may still be placed. However, when integrating a display into a cooking surface and providing touch controls, there is an increasing likelihood of a user attempting to use the touch control elements of the display in an area that may pose a temperature risk. This disclosure provides additional solutions to recognize objects placed on the cooktop and to organize the graphical content to enhance user safety.

In some examples, in order to properly dissipate heat, the display panel may be separated from the cooktop surface to provide a space for sufficient insulation to prevent a hot object (e.g., the cookware object 22) resting on the cooktop surface from heating the cooktop surface and the underlying display. In some examples, in addition or alternative to the dissipation layer between the display and the cooktop surface, a dissipation layer is disposed between the cooktop surface and the cookware object 22. As shown in FIGS. 6A and 6B, this dissipation layer is provided by insulating pads 32 disposed at the bottom surface of the cookware object 22, such as the pan. For example, the pads 32 may include a scratch-resistant material or an impact-resistant material for interfacing with the cooktop surface. For instance, these pads may be silicone, ceramic, high-temperature polymer, or other non-conductive material. By having a heat dissipation layer between the cookware object 22 and the cooktop surface 28, the dissipation layer may reduce conductive heating of the cooktop surface.

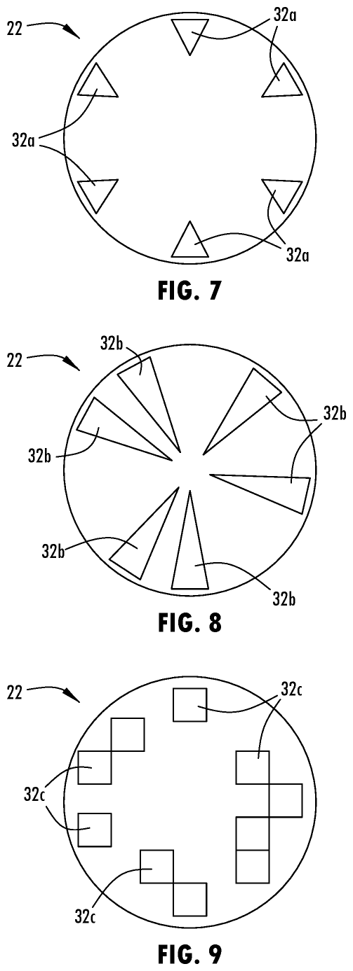

As shown in FIGS. 7-9, additional examples of cookware are shown having a number of thermally insulated pads 32a, 32b, 32c installed on the bottom of the cookware 22, such as proximate a periphery of the cookware 22. The pads 32a, 32b, 32c may be formed as geometric shapes or patterns and may be located near the perimeter of the cookware. The touch sensor of the cooktop system can distinguish the pad 32a, 32b, 32c locations and shapes, allowing the cookware 22 to be uniquely identified. This may be done using geometric shapes (e.g., squares, triangles, circles, or irregular shapes having multiple sides, vertices, or lobes) that are distinguishable to the sensor system, such as to distinguish between the associated cookware 22. In addition, the locations of the pads 32a, 32b, 32c near the perimeter of the cookware may provide information regarding the size of the cookware 22. This information can be used to inform the induction power delivery controls of the location of the cookware 22, and the power and heating parameters of the cookware 22 may be stored in memory using the unique identifier provided by the pad 32a, 32b, 32c geometries and patterns. In addition, the cookware size and location information can be used to control the size and location of the graphics used on the display, where a set of perimeter graphics may be used to indicate cookware 22 location and power delivery. Alternatively, the pads 32a, 32b, 32c may be used in a pattern across the bottom surface of the cookware 22 in a 1-dimensional (linear), 2-dimensional (X-Y), or radial pattern to encode information about the cookware 22. When using pads 32a, 32b, 32c in a pattern, the pads 32a, 32b, 32c must be placed with sufficient radial symmetry to ensure that the cookware 22 does not tip or become unstable when resting on a surface. For example, the pads 32a, 32b, 32c should not be placed more than 60 degrees apart on a circular piece of cookware 22 and should be located within 25% of the outer radius of the cookware 22. These pads may also be used as a thermal isolation layer reducing the heat transfer from the cookware to the cooking surface below or to a resting surface by conduction once removed from the cooktop. In these embodiments, the frequency response touch sensor must be located on or below the cooking surface and may utilize a number of sensor technologies, such as capacitive, resistive, SAW, IR, or other known sensors.

When using a capacitive-based touch sensor within a cooking surface with heatable elements, a user will often place metal objects on the cooking surface such as ferrous metal cookware. This ferrous metal may cause the capacitive sensing system to significantly alter its sensing capabilities by impacting the electric field generated above the sensor. This may negatively impact or prohibit the touch sensor from being able to detect an object or limit the resolution of the sensor to determine the object's outline. By periodically scanning the induction coils in addition to the capacitive touch system, the induction system may detect the presence of a ferrous metal item and communicate the location to the capacitive touch system. The capacitive touch system (or any other frequency response touch sensor system) may use this information to recalibrate or alter its sensing characteristics to account for the presence of a ferrous metal object.

Referring to FIG. 10, a removably positionable control knob 50 may be used with the cooktop system that utilizes the underside features on the bottom surface of the knob 50, such as shown in FIG. 11, to communicate additional information to the cooking surface. The knob 50 includes an upper movable portion 52 that rotates about a central axis relative to a lower portion 54 that, when the upper movable portion 52 is operated or rotated, is configured to rest in a fixed position on a surface (e.g., the cooktop surface). In one alternative the upper or top portion is both rotatable and displaceable relative to the lower or bottom portion. That is the top portion 52 may be displaced toward the bottom portion 54 similar to pressing the top portion 52 like a button. When a movable control knob 50 is placed on the cooktop, in some examples, such as shown in FIG. 11, the bottom surface may include a pattern of pads 56a, 56b that are used, along with the overall size of the array of pads, to communicate to the cooktops touch sensor array that is sensing the bottom surface of the knob. In addition, the cooktop may detect movement or rotation of the knob and may detect a change in the location of the pads. In this example, the bottom surface features may be plastic, metal, ceramic, glass, or any other material that may be easily detectable by the touch control surface. For example, a non-ferrous metal may be most easily detected by a capacitive touch screen as it has the greatest impact on the electric field generated by the capacitive sensors. Alternatively, a harder material such as glass or ceramic may cause increased feedback for a resistive touch sensor array.

Sliding the knob or other object sensed on the cooktop may be detected and used to control the system. For example, a visible power scale may be displayed on the cooktop, where the sliding motion of the object along the axis of the scale may increase or decrease power. Additional functions, such as menu controls, timers, or other forms of user input may be determined through this detected sliding motion. Rotational information may be detected by the touch controls and used to control the cooktop such as changing menu selections, controlled cooking power, or other forms of input and feedback to the control system. In addition, the knob may have multiple underside contact points. As can be seen in FIG. 11, an outer array of pads A may be used as the knob identification pattern. Pad array B may be used to communicate rotational information to the cooktop, where the user rotates the knob, pad array A remains in a fixed location but pad array B rotates. In addition, a button may be located on the control knob where once a user presses the button, an additional pad makes contact with the cooking surface such as pad C. Alternatively, where the top portion is displaceable relative to the bottom portion, the pad array A is in contact with the cooktop surface and sensed by the sensor array while the pad array B is out-of-contact with the cooktop surface and not sensed by the senor array. Displaying the top portion toward the bottom portion brings the pad array A coplanar with pad array B so that both pad arrays A, B are in contact with the cooktop surface and sensed by the sensor array. This button may be spring loaded or use other mechanisms to create an “on” and “off” binary detection without secondary user actions.

Furthermore, the knob or other object sensed on the cooktop may provide an input to the system when it is deliberately removed from the cooktop surface. For example, the system may respond to the knob being removed by altering the power to the system, displaying a different user interface, or recognizing a different set of controls. For examples, when the knob is removed, the system may be configured for the power to the induction coils to cease or otherwise substantially reduce, such as below a threshold temperature, to operate as a safety measure. Such a safety mechanism could be employed in a situation where the contents of the heated cookware spills or boils over onto the cooktop, where removable of the knob is recognized as the input to stop heating the associated cookware. As another example, removing the knob may also result in a different user interface image, such as a new display prompting the user to return the knob to the cooktop in a desired location. As a further example, removing the knob may result in the display generating a user interface with touch compatible graphics and the sensor array monitoring the area of on the cooktop corresponding to the touch compatible graphics.

Alternatively, such as if a cookware item does not have identifying pads located on the underside of the item, the system may use information regarding the size of the cookware item—using its touchscreen or induction array capabilities to find the edges of the object—coupled with temperature information when available from the sensor array near the surface to identify a pan that may have been recently placed on the cooktop. For example, if a piece of cookware without identifying pads is picked up off the cooktop during a cooking cycle and placed back down onto the cooktop in a new location, the system may use a touchscreen sensor to determine the size and shape of the cookware, and the temperature information from its temperature sensor array to determine the temperature of the item. If the size and temperature of the item match the characteristics of an item previously removed from the system, the system may assume that the item is the same item. The system may further enhance this capability by calculating the temperature of an item that has been removed over time, where the item may cool the longer it has been removed from the cooktop. This calculation may use the thermal characteristics recorded during the heating of cookware, such as the change in temperature over time for a given amount of applied power. The system may also use the objects size and/or weight to calculate the cooling rate of the item with time. The system may use separate touchscreen sensors and temperature sensors, or the system may incorporate both sensors into one sensor array.

The cooktop 10 may use a dedicated movable control knob with such features, or it may create virtual control knobs by adding the rotational control capabilities to other objects that use bottom surface pads as described. In this example, the cooktop may detect the rotation of a piece of cookware 22 and use this rotating motion to increase or decrease the amount of power being applied to the piece of cookware 22. In this embodiment, the user rotates the cookware 22 on the cooking surface 28 while maintaining contact between the cooktop 10 and the piece of cookware 22, allowing the cooktop 10 to detect the rotation. If a user wants to rotate a piece of cookware 22 without altering the applied power, the user may pick up the piece of cookware 22 and rotate it, then place it back down. In this case, the cooktop 10 will detect that the same piece of cookware 22 has been placed back down, and though may be rotated, will not apply a rotational control adjustment because it detected the removal of the cookware 22.

With further reference to incorporating a touchscreen display over an induction coil array, to enable a versatile cooking and display surface, it is desirable to space the graphics and touch controls in such a way to allow for the display of graphical content without objects covering or blocking the view of the graphics. In addition, safe placement of touch controls is desirable to prevent the system from directing a user to touch a hot surface.

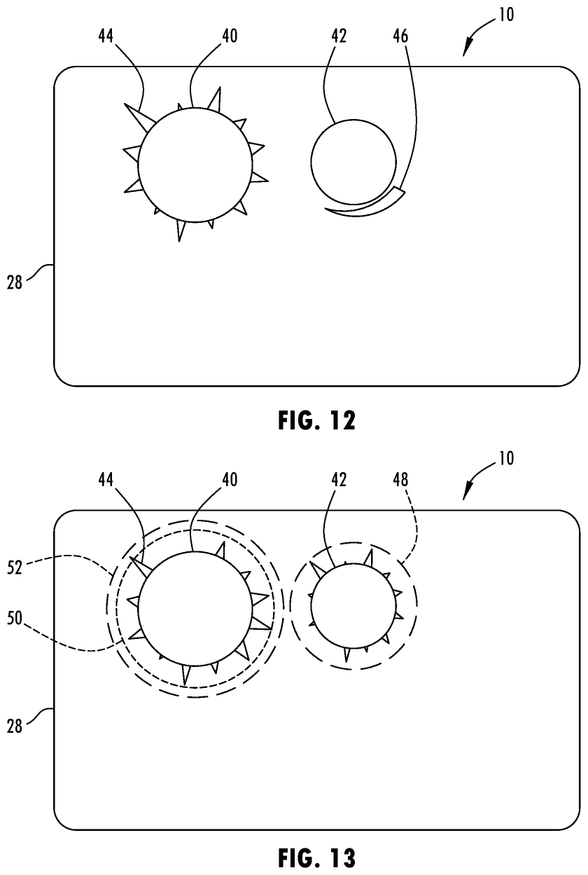

As shown in FIG. 12, two pieces of cookware 40, 42 are shown on the cooking surface 28, where graphical representations of delivered power is being shown under and around the cookware 40, 42. For example, a graphical flame 44 may be displayed resembling a gas burner. Alternatively, a lighted ring, radial level indicator 46, or other graphical representation of power delivery may be used. To properly size the graphical representation of power, the outline of the cookware item is determined as accurately as possible. This may be done using any combination of user input information regarding cookware items, touchscreen input from the contact with the cookware which may include identifying pads, or feedback from the induction system, where an array of coils is used in conjunction with electrical feedback to determine the coupling of each coil to the cookware item. By optimizing the size of the graphics 44, 46 around the cookware items 40, 42, the cooktop 10 can prevent that the graphics 44, 46 from being covered by the cookware items 40, 42 while also ensuring that the graphics are not so large so as to prohibit other cookware items from being placed nearby. Graphics may also be modified to slightly offset the cookware item when the item is not optimally placed over the induction coils, encouraging a user to move the cookware item to a more optimal location.

The graphical content may have a dynamic response to the location, power levels, temperature, and movement of the cookware items. For example, when sliding a cookware item in a lateral direction, a graphical representation of a gas flame or campfire may simulate the movement of air across the flame in the same direction as the pan. This simulated air movement may be proportional to the speed at which the cookware item has been moved. In another example, setting a cookware item onto an area with graphical representation of flames or heat, these areas may respond by appearing compressed, spread, or affected by the placement of the cookware item.

Referring to FIG. 13, a keepout zone 48 is created around the cookware 42. In this example, the cooktop 10 may create a fixed size keepout zone 48 around the cookware to maintain a minimum safe distance to create graphical touch controls. Alternatively, the cooktop 10 may dynamically adjust the size of the keepout zone 48 based on the size and type of cookware, presence of thermal insulating pads, amount of power being delivered or previously delivered, the presence of other cookware, or any combination thereof. The cooktop 10 may estimate the temperature of the cookware 42 based on the power delivered and duration and calculate the estimated surface temperature based on the thermal conductivity of the surface material, such as ceramic-glass, based on distance from the cookware. This calculation may be further enhanced by measuring the ambient environmental temperature and incorporating any added heat from other nearby cookware. Alternatively, the temperature of the glass surface or subsurface may be measured directly by the sensor array.

In addition to a keepout zone 48, the control system 34 may determine an additional keepout zone 50 wherein this second keepout zone 50 is the area within which the systems performance may degrade when another object is placed within this keepout zone 50. For example, when two cookware items 40, 42 are placed too close to one another, the cookware may couple to induction coils near both items, causing the systems power control to become less predictable. To discourage a user from placing cookware or other items within the placement keepout zone 50, the graphical content 44 may be enlarged to match this keepout zone 50. For example, a virtual gas flame or campfire may be displayed under a piece of cookware 40 with a graphical image extending two inches beyond the periphery of the cookware item 40 to indicate to the user that this zone 50 is being used for the primary cookware 40 and other items should not be placed within this zone 50.

With continued reference to FIG. 13, the system may determine a touch keepout zone 52, wherein the touch keepout zone 52 is the area within which the potential for heat dissipation into the cooktop 10 presents a risk of discomfort or injury to a user should the user attempt to engage a touch control function. Although illustrated where the touch keepout zone 52 is larger than the placement keepout zone 50, this is not intended to be limiting and other alternatives are contemplated where the touch keepout zone 52 is the same size or smaller than the placement keepout zone 50. The touch keepout zone 52 may disable touch control functionality outside the periphery of the cookware item 40. The cooktop 10 may be configured to generate a graphical illustration on the display 24 as a boundary of the touch keepout zone 52 or an illumination of the entire area of the touch keepout zone 52.

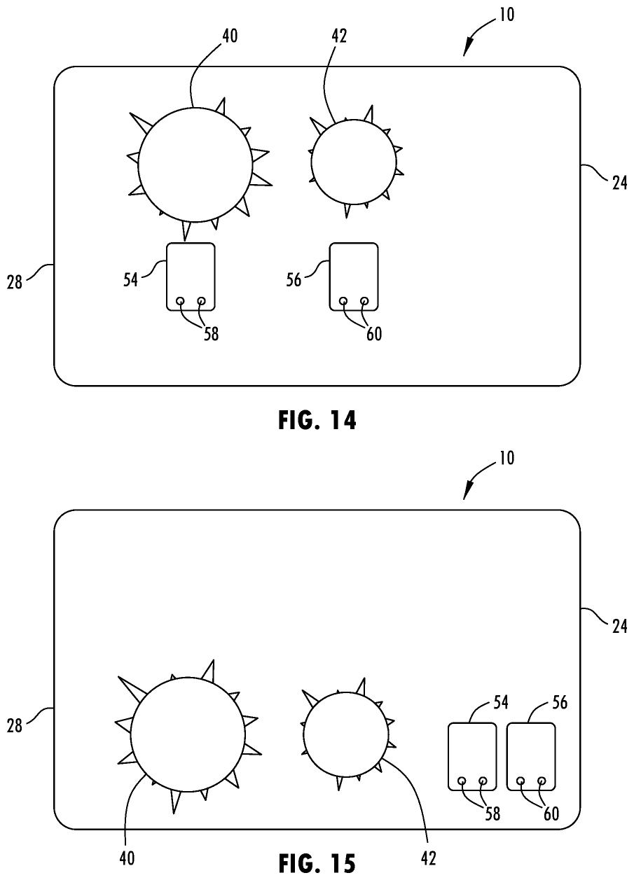

As shown in FIG. 14, the menu information and user input controls for associated cookware as generated by the display 24 and visible on the cooktop surface 28. In this example, the information about the cookware 40, 42 is presented towards the top of the graphic 54, 56 while the user touch controls 58, 60 are presented at the bottom, furthest away from the cookware as it is a source of heat. Although two user touch controls 58, 60 are illustrated, this is not intended to be limiting. For example, the user touch controls 58, 60 may include a temperature increase control and a temperature decrease control, respectively. Other alternative control arrangements are contemplated within the scope of this disclosure, including a single user control to toggle between incremental temperature values, or three or more user controls to toggle heating operations on/off, adjust temperature, adjust timer duration, etc. As oriented in the illustration, the bottom is contemplated to be the near edge for user access, such that the user would need to reach across the surface 28 of the cooktop 10 to reach the top edge.

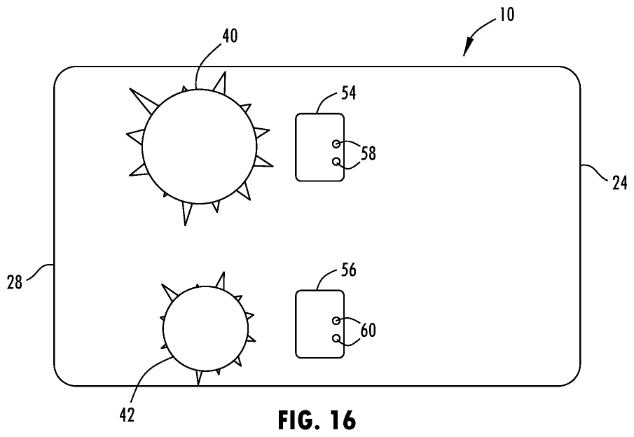

FIG. 15 shows the same menu information graphics 54,56 as FIG. 14, except when the cookware 40, 42 are located near the front of the unit, the information graphics 54, 56 and touch controls 58, 60 are moved to the side to avoid areas that may be hot and to prevent a user from having to reach over a hot cookware item 40, 42. FIG. 16 shows an example of a multi-pan embodiment where two pieces of cookware 40, 42 are located on the cooktop 10 with sufficient space in between the cookware 40, 42 to place graphics 54, 56 and touch controls 58, 60. In this example, the cooktop 10 places the controls 58, 60 for the rear cookware 40 to the side of the cookware 40 to prevent a user from having to reach over the front cookware to use the touch controls 58 for the rear cookware 40. Additionally, the cooktop 10 may place the controls 58, 60, to the side of the graphic 54, 56 furthest away from the cookware items 40, 42 to minimize the potential exposure of the user to increased heat while accessing the controls 58, 60.

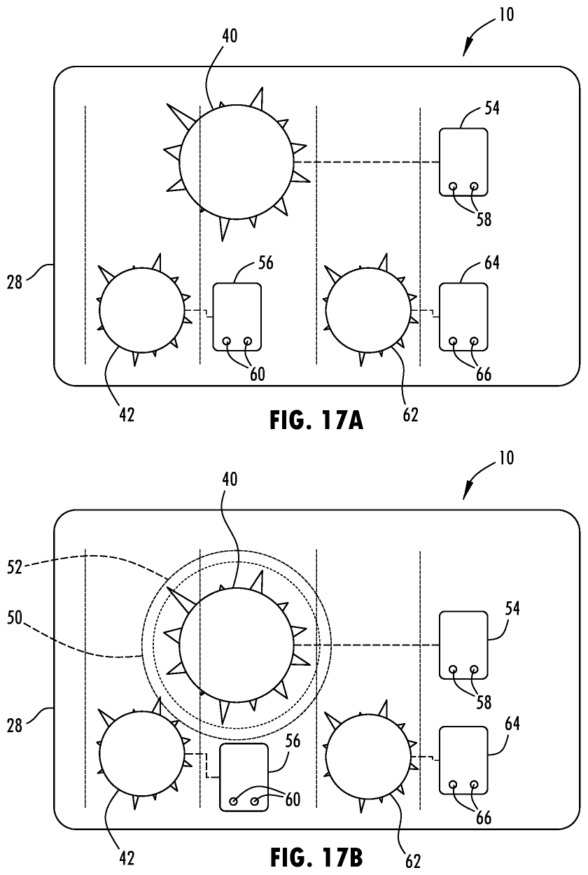

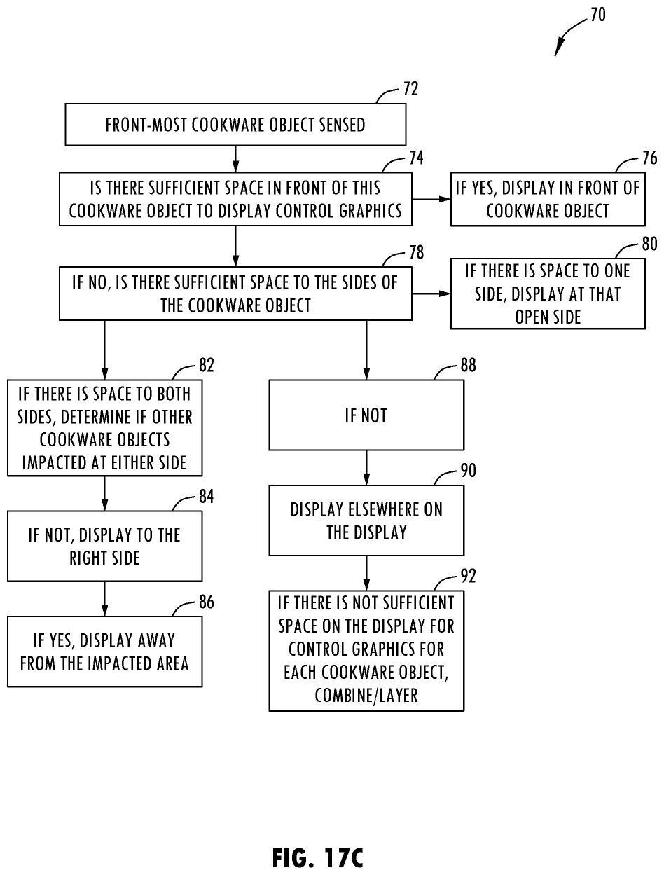

Referring to FIG. 17A, an example of a multi-pan embodiment is provided that shows three pieces of cookware 40, 42, 62 are located on the cooktop 10. In this example there is sufficient space in front of and next to the rear cookware item 40 for graphics 54 to be located. However, the presence of graphics 54 in front of the cookware 40 along with cookware items 42, 62 in the front of the cooktop 10 causes the cooktop 10 to locate cookware information graphic 54 for the rear cookware item 40 horizontally from the cookware item in a column that does not have a piece of cookware 42, 62 in front of it. These columns are created behind cookware at a width defined by the characteristics of the cookware item. For example, columns may be created with widths that are 25% wider than the assumed diameter of the cookware item. Alternatively, the columns may be dynamically increased or decreased based on the known height and/or power being delivered to the cookware item. For example, a flat pan with low power being delivered may create a column that is the width of the cookware item since a user can more easily see over and reach around the flat item. A column may be increase to 50% larger than the diameter of the cookware item when the cookware item is a large stock pot that may be tall, making it harder for the user to see and/or reach around the stock pot. These columns are used to locate graphics wherein graphics and/or touch controls are not placed in columns where the cookware item becomes located between the user and the graphic.

FIG. 17B shows the keepout zones 50, 52 used to locate graphics 54, 56, 64 and controls 58, 60, 66, wherein the columns from FIG. 17A are used to align graphics 54, 56, 64 and touch controls 58, 60, 66 in a way that prevents a user from reaching over a hot cookware item 40, 42, 62. The graphical and touch keepout zones 50, 52 are used and extend radially from a piece of cookware 40 to discourage placement of items too close to one another and to keep touch controls from being located too close to areas with a high surface temperature.

As example method 70, executable by a control system 34 of a cooktop 10 for placing graphical content related to cookware, is shown in FIG. 17C. Initially, the method 70 starts with the front-most cookware item sensed on the cooktop at step 72, where front-most is determined as most proximate to an expected user position for accessing the cooktop. At the next step 74, the control system determines if there is sufficient space in front of the cookware item for graphics and touch controls. If yes, the cooktop 10 displays the graphics and controls in front of the cookware item at step 76, that is, between the cookware item user's position. If no, the cooktop 10 determines if there is sufficient space next to one side, the other side, or both sides of the cookware item for graphics and touch controls at step 78. If the cooktop determined that there is sufficient space at only one or the other side, the cooktop 10 displays the graphics in the open side at step 80. Otherwise, if it is determined that there sufficient space next to both sides of the cookware item for graphics and touch controls, the control system determines if there are other cookware items that may need to locate graphics and controls at step 82. If there are no other cookware items, the cooktop displays the graphics and controls nearest the right side at step 84. The right side may be a default position considering the statistical prevalence of right-handed users. The default preference for the right side may be a user adjustable setting. If it is determined that there are other cookware items that need to place graphics and controls, the cooktop 10 displays the graphics and controls on the side away from the other cookware item at step 86. If it is determined that there is not sufficient space on either side at step 88, the system displays the graphics on the side of cookware item nearest the edge of the cooktop at step 90. If there is sufficient space for graphics and controls within the same row or further forward elsewhere on the display, the graphics are displayed to that location. If there is not sufficient space, the system may prompt or direct the user to move or relocate one item, reduce size of graphical content, or eliminate graphical content at step 92. The steps of the method 70 are repeated for all other cookware items present on the cooktop.

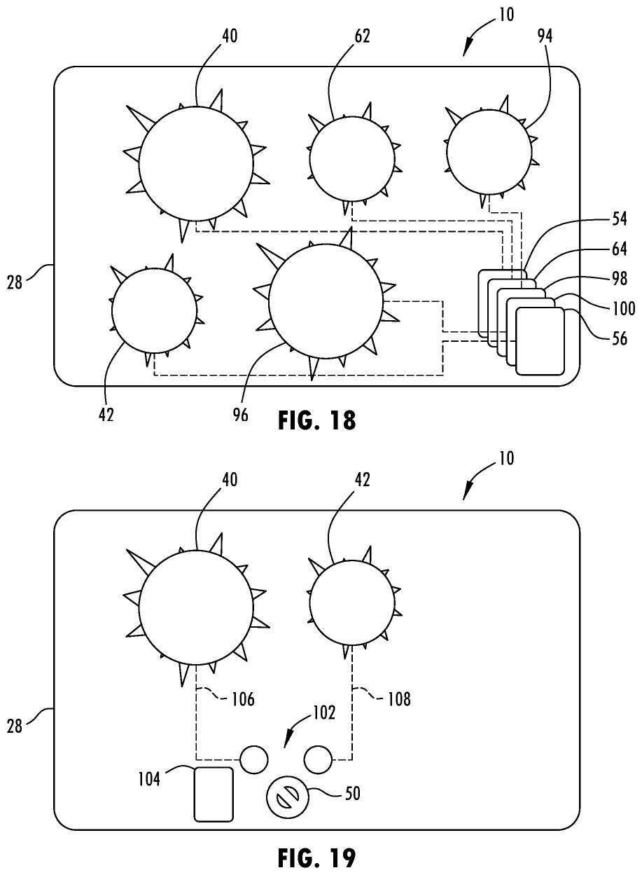

If there is insufficient space to distribute the display of graphics and controls 54, 56, 64, 98, 100, the system may also combine and layer graphics with content for other cookware items 40, 42, 62, 94, 96, such as shown in FIG. 18. In FIG. 18, an example of a multi-pan embodiment is provided where there is insufficient space for graphics and controls 54, 56, 64, 98, 100 to be located near the cookware items 40, 42, 62, 94, 96. In this embodiment, the control system 34 of the cooktop 10 layers and groups the information and co-locates the information in one area of the display 24 as a stack. The user may select different cookware items to control or select for information to be displayed using a scroll wheel, selection arrows, touching or clicking directly on the tab of interest, or any other type of multi-layer menu selection.

FIG. 19 shows the use of a movable knob 50 to control the cooktop 10 when multiple cookware items 40, 42 are present. In this example, placing the knob 50 onto the cooktop 10 initiates a selection menu 102 wherein the user selects which cookware item 40, 42 the user would like to control. The system may set the default cookware selection to the item nearest the location where the knob 50 has been placed. The user may select this item using the touchscreen, a button on the knob, or the system may use a time-delay feature wherein after a period of time (for example, 3 seconds), the control system selects the cookware item and a secondary menu 104 is opened. The cookware item 40, 42 may have a graphical representation shown in the display near the knob that is representative of the type of cookware, the contents, or may use a generic image. In addition, the system may further indicate which piece of cookware is being selected by showing a leader line 106, 108 connecting the cookware to the knob selection area. Alternatively or in addition to a leader line 106, 108, the cookware being controlled may be labeled with text or a sequential numbering scheme, the graphics may change color beneath the cookware item and match the color of the graphics near the knob, or may, the graphics from non-selected cookware may be changed to grayscale, semi-transparent, or be reduced in size, or the graphics for selected/non-selected pans may be animated in a way to indicate which cookware is being selected.

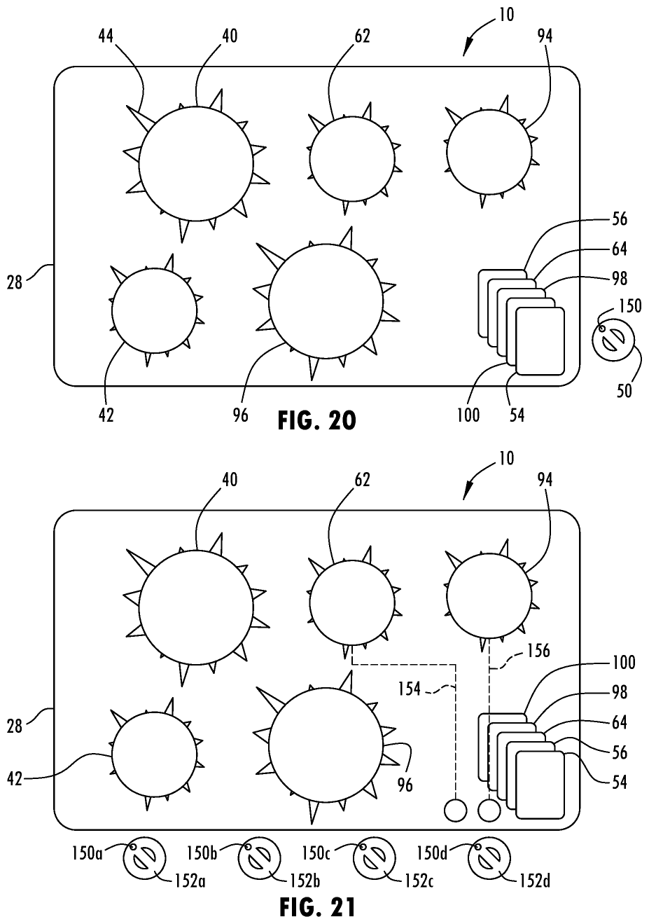

As shown in FIG. 20, an example of the cooktop is provided with multiple cookware items present and a movable knob 50 located off to the side of the cooktop. In this example, the color of the graphics 44 under a piece of cookware 40 is changed to match the color of the associated menu or graphics 54 on the display 28 that presents information about that particular item of cookware 40. In addition, an LED 150 on the movable knob is changed to further indicate which item of cookware is being controlled. Alternatively, the movable knob 50 may use an integrated display 152 (shown in FIG. 10) to present additional information or information that no longer fits onto the cooktop 10.

As also shown in FIG. 21, an implementation where multiple permanently attached control knobs 152a, 152b, 152c, 152d are used in conjunction with a cooktop 10 with a versatile cooking surface 28. In this example, there are more cookware items 40, 42, 62, 94, 96 than there are knobs 152a, 152b, 152c, 152d. In this example, control knobs 152a, 152b, 152c, 152d become associated with cookware items 40, 42, 62, 94, 96 as the cookware items 40, 42, 62, 94, 96 are placed onto the cooktop 10 where the closest control knob 152a, 152b, 152c, 152d to the column axis of the cookware item 40, 42, 62, 94, 96 is selected as the control knob 152a, 152b, 152c, 152d for that particular item of cookware 40, 42, 62, 94, 96. Once all of the control knobs 152a, 152b, 152c, 152d have an associated cookware item 40, 52, 62, 96, if an additional cookware item 94 is added, the control system 34 provides an item selection step associated with the knob 152d to allow a single knob to control multiple cookware items 62, 94. Leader lines 154, 156, graphical/led colors, and other coupling indications are provided to display the association between a knob 152d and a cookware item 62, 94. In this example, the permanently attached controls 152a, 152b, 152c, 152d may be knobs, buttons, dials, levers, switches, or any other type of physical user interface.

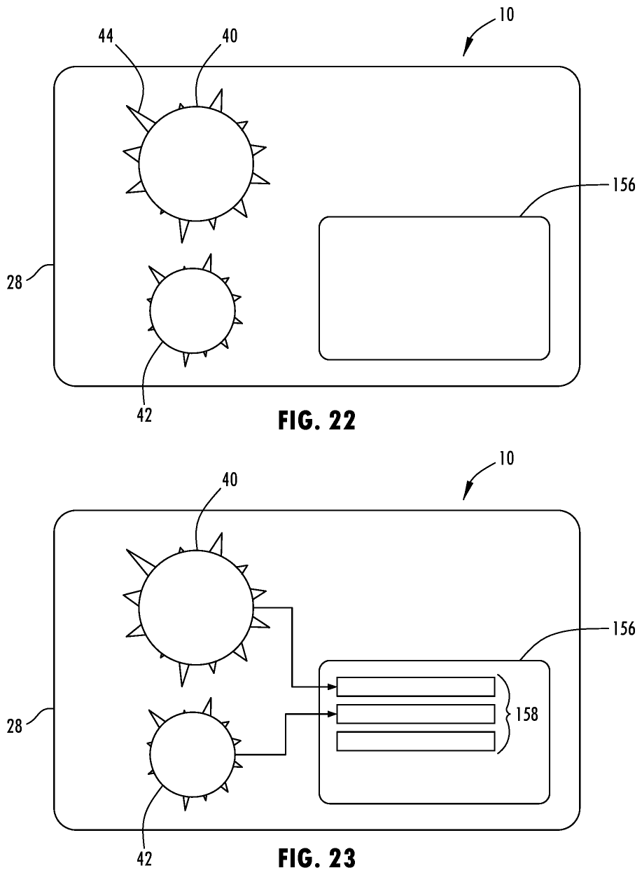

Referring to FIG. 22, an example is shown with a large portion 156 of the cooktop 10 is used to display graphical content that is independent of the cookware items 40, 42 that may be present. In this example, a large video or graphic is displayed in the portion 156 of the cooktop 10 where there are no items of cookware 40, 42. The cooktop 10 may prioritize the front portion of the cooktop 10 for this type of graphical content wherein the cooktop guides the user to place cookware items 40, 42 to the side and behind the display 156 when the content is active. This may be done by prompting the user with text information that the induction heating capabilities may be disabled within the area 156 being used to display graphical content. Optional heating locations may be indicated on the display with instruction for the user to move cookware items 40, 42 to these areas. If the user disables this or if the areas available for induction cooking have become filled, the system may reduce the size of and move the graphical content 156 to allow for more heating areas. Alternatively, the system may indicate that the area 156 of the cooktop used for graphical display may be used again for induction cooking. In some examples, the cooktop may include pre-loaded or otherwise accessible recipe content that operates the user interface to direct the user where to place pans, such as with a virtual burner displayed in a different color and/or with a label associated with a step of the recipe. For instance, a recipe may instruct a step to boil water and when the boiling step of the recipe is selected by the previous steps being completed, the cooktop may illuminate a pot location and/or display a label associated with the step (e.g., “Boil” or “Hi”) on the burner location. Subsequently, the recipe may instruct a step to prepare a sauce and when the sauce step of the recipe is reached by the previous steps being completed, the cooktop may illuminate a sauce pan location and/or display a label associated with the step (e.g., “Sauce” or “Med”). The recipe content can also autonomously control the heat settings based on the recipe, such as the temperature and cooking time.

As shown in FIG. 23, an example where a large portion 156 of the cooktop 10 is used to display graphical content includes content 158 related to multiple cookware items. This graphical content 158 may be an instruction video, recipe, or other information related to multiple cookware items, ingredients, or cooking steps. In this embodiment, a pre-determined set of content 158 may be coupled to the dynamic placement of cookware 40, 42 and graphical content. For example, a cooking instructional video may use pre-recorded content that adapts the location of information presented on the display to match the current cooktop settings. Arrows, text, or other graphical information may be overlaid onto the video to connect information being provided to a specific piece of cookware. In addition, the video may periodically pause or alter its playback speed to match variation in the speed and timing of the user following the steps provided.

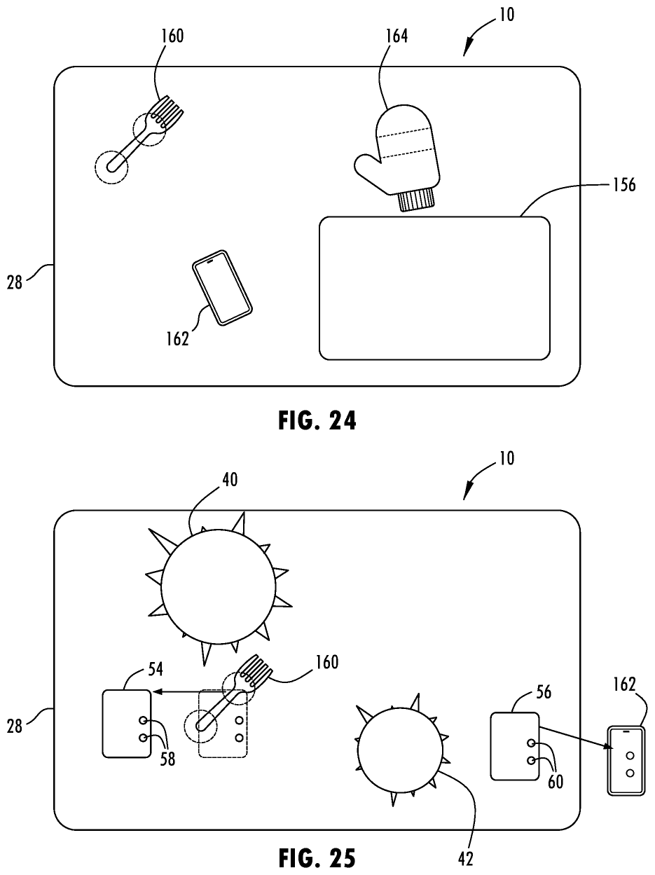

Referring to FIG. 24, a cooktop 10 is shown where multiple non-cookware objects 160, 162, 164 are located. In this implementation, the touchscreen feature 36 of the cooktop 10 enables the cooktop 10 to measure a preliminary set of object characteristics before induction power is applied to the objects 160, 162, 164. For example, a fork 160, or other similar utensil with a curved profile may make contact in two small areas spaced apart from one another. In this example, the cooktop 10 may determine that the two small contact locations within a short distance that are detected at approximately the same time likely belong to a metal fork or other utensil that is likely dangerous to apply induction power to. The control system 34 may generate an alert or inform the user, remove induction power from an area near the fork 160, may visually indicate the presence of the object, or may take no further action. Other objects such as a mobile phone 162 may be damaged with the presence of any induction power, in which case the physical size and rough outline of a rectangular device that is smaller than most cookware items may be determined or assumed to be a mobile phone 162. In this example, the cooktop 10 may remove all induction power near the phone. In addition, items that may not be damaged or cause a risk to the user may still cover graphics from the cooktop 10. In this example, an oven mitt 164 is placed on the display 24 with the touchscreen capabilities 36 detecting the presence of an unknown object. In this example, no action is taken from a power and induction control standpoint, however the graphics 156 may be moved or resized to account for the presence of an object that may obstruct the user's view of important graphical information.

FIG. 25 shows an embodiment wherein a cooktop 10 with several cookware items 40, 42 and a foreign object 160 are present. In this example, the detection of a foreign object allows the system to move the location of the graphical information and touch controls 54 for the cookware item 40 laterally to prevent them from being covered by the foreign object 160.

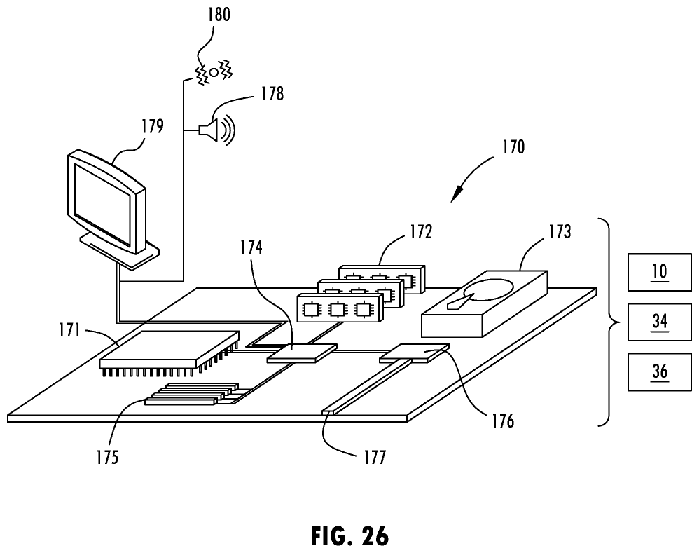

To enhance the usability of an induction cooktop 10, the control 34 system may incorporate audio feedback, via a speaker 178 (shown in FIG. 26). In one embodiment, a speaker 178 or other audio system is used to mimic the “click” sounds of a traditional gas burner electric starter. In another embodiment, the sound of a gas burner is projected through the audio system with its intensity matching the user input power level. For example, when a user selects a “high” setting while using a simulated gas range setting, the audio system plays the maximum volume of a gas burner. This sound may remain on for the duration of the power delivery and may be combined with audio levels from multiple burners. For example, when 3 burners are set to “high”, “medium”, and “low”, the audio system combines the volume levels of the associated 3 burners into one audio signal with an equivalent volume to a real 3-burner gas range. In another example, the simulated gas burner audio may be played for a short duration after starting or after every adjustment of power, providing an audio feedback to the user only long enough for them to receive audible feedback regarding the new power level. This period may be as short as a few seconds, after which the audio signal may be stopped, suddenly faded, or slowly faded. This audio feedback may also be played every time a user switches control to a new piece of cookware. Other examples of audible feedback may include the sound of a campfire, boiling water, or simulated cooking sounds such as searing or frying. These audio feedback mechanisms may be made to coincide with graphical content such as a growing campfire or gas burner, graphical representations of water boiling, or other visual content.

To enhance the usability of an induction cooktop 10, haptic or mechanical feedback may be used. In one embodiment, a touch control on the cooktop may provide a haptic touch feedback wherein a vibration motor 180 (shown in FIG. 26) or other exciter is used to vibrate the glass or touch surface as a user touches the surface or controls in a predetermined area. This mechanical feedback may alter its intensity and duration for different elements of user feedback. For example, button presses may use a short, lower intensity vibration feedback. However, when user is detected touching an area of the cooking surface that is likely hot and may cause harm, the intensity of the haptic feedback is greatly increased as a means to give a stronger warning to a user. In addition, this haptic feedback may be combined with an audible warning such as a horn, siren, or tone that quickly indicates to a user that they have touched in an area that is unsafe. In addition, haptic feedback of the touchscreen surface may be enabled using an audio exciter that is mechanical fixed to the cooktop surface and used a low frequency range, such as 5 hz to 800 hz.

Additionally, haptic feedback may be used with movable or fixed knobs 50, 152a-d that incorporate dynamic torque controls. In this embodiment, a multifunction knob 50, 152a-d may simulate a gas-range control by using a high dynamic torque to simulate a detent on a gas range used to activate the electric flame starter. In addition, increasing rotational resistance may be applied to the knob to simulate an increase in power being applied to a piece of cookware. This mechanical or haptic feedback may be combined with audio feedback to provide an audible “click” that provides a user with a familiar sound of a gas range starting. Visual feedback may also be incorporated to show elements associated with knob control such as a spark as a simulated gas burner is turned on or visual detents located on the display under the movable knob 50.

Graphical content displayed on the cooktop 10 must be done in a manner that is clear and/or readable to the user. A cooktop 10 that is installed in a countertop 14 with a wall or other obstruction behind the cooktop 10 may not require any adjusting or user input to ensure alignment of text to viewing angles as the user will always be near or towards the front of the unit. However, a cooktop 10 installed into kitchen islands or other work areas wherein a user may approach and/or use the cooktop 10 from multiple angles has an additional challenge of adapting graphics to ensure readability and usability.

In one embodiment, a touch or menu control option provides the user with a means to set the text or orientation of the cooktop 10. In this embodiment, the cooktop 10 rotates all text graphics so that a user standing in the location indicated can read the text in a normal fashion. In addition, the cooktop 10 may alter the locations of graphical content as described in FIGS. 17A-17B and the associated flowchart shown in FIG. 17C with a new “front” of the unit, ensuring that when used from an alternate angle a user is still not required to reach across a hot pan or have their view obstructed.

In another embodiment, a sensor is used to determine the presence of users near the cooktop 10, providing the cooktop 10 with the means to automatically determine the location of the user and the associated direction/orientation of graphics and text. These sensors may be infra-red, motion detection, light curtains, ultrasonic time-of-flight sensors, or any other sensor known in the art. In addition, the cooktop 10 may provide an option for the user to “lock” the orientation of the graphics. This may be required in an environment where many people may be near the cooktop 10 but only one is using the cooktop 10. In another example, a cooktop 10 may split the graphical content to display information in multiple directions towards the nearest perimeter of the cooktop 10. In this example, cookware may be located near the middle of the cooktop with information and graphical content oriented between the cookware and the edge of the cooktop. This user presence sensor can also be used to “wake” the unit from any idle, lock, or standby modes.

In another embodiment, the cooktop 10 may automatically assume the location of a user by detecting where the first touch or cookware items are present while the unit is idle. For example, in idle the cooktop 10 may have an unlock feature that directs the user to touch one of several predetermined locations or anywhere on the cooktop 10 to initiate use of the cooktop 10. If the user touches in a location towards ones side of the cooktop 10, the control system 34 may assume the user is standing along that side.

In one embodiment the cooktop 10 may use an idle mode wherein the display is set to a default image. This image may be user selected, user uploaded, or may be used from a preset list of graphics. In one example, the user uploads a photo of the countertop 14 nearby the cooktop 10 via a WiFi or other wired or wireless interface. Once uploaded, the cooktop 10 displays this image when in idle mode to make the cooktop 10 appear like the nearby countertop 14. This process may be completed by a user, an installer, or factory. The image used may be a photo or may be supplied by a third party that manufactures countertop surfaces. Once uploaded, the cooktop 10 may adjust the color or brightness to account for any opacity or coloration of the materials present in the display 24 and surface 28. The cooktop 10 may also resize, tile, stretch, mirror, or apply other image adjustment methods to fill the entire display 24 with the desired image or patterns.

The cooktop 10 may have additional states such as idle, lock, or standby. In idle mode, the display 24 may be powered on and displaying a default image or set of graphics being shown while a user is not present and no cooking is taking place. This may be with the display 24 set to a lower brightness to conserve energy relative the brightness in other operating modes. In another example, the display 24 may show graphics in only one portion of the display. In this example, a backlight may be turned off in areas not in use. In addition, the control system 34 may choose areas of the display 24 to present graphics that are used less to more evenly distribute the usage of the display 24.

In standby mode, the control system 34 may turn the display 24 off and use either the touchscreen sensor, user sensor, or some other manual user input to wake the cooktop 10. This mode may be used to lower the power drawn by the cooktop 10 when not in use and when no image needs to be displayed. For example, at night or when there are no occupants in a building. The control system 34 may switch from idle to standby based on a time-based schedule, time-based delay from last use, by detecting via wireless sensors or radios associated with users such as connected Bluetooth or WiFi devices, or other scheduling or activity-based monitors.

In lock mode, the cooktop 10 may present graphics similar to idle mode or with a display off such as standby mode, but may prevent a user from controlling the cooktop 20 until a particular sequence is used to unlock the cooktop 10.

FIG. 26 is schematic view of an example computing device 170 that may be used to implement the systems (e.g., systems 10, 34, 36) and methods described in this document. The computing device 170 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 170 includes a processor 171 (e.g., data processing hardware), memory 172 (e.g., memory hardware), a storage device 173, a high-speed interface/controller 174 connecting to the memory 172 and high-speed expansion ports 175, and a low speed interface/controller 176 connecting to a low speed bus 177 and a storage device 173. Each of the components 171, 172, 173, 174, 175, 176, 177, are interconnected using various busses, and may be mounted on a common motherboard or in other manners as appropriate. The processor 171 can process instructions for execution within the computing device 170, including instructions stored in the memory 172 or on the storage device 173 to display graphical information for a graphical user interface (GUI) on an external input/output device, such as display 24 coupled to high speed interface 174. Other input/output devices, such as speaker 178 and haptic device 180, may be in communication with the computing device 170. In other implementations, multiple processors and/or multiple buses may be used, as appropriate, along with multiple memories and types of memory. Also, multiple computing devices 170 may be connected, with each device providing portions of the necessary operations (e.g., as a server bank, a group of blade servers, or a multi-processor system).

The memory 172 stores information non-transitorily within the computing device 170. The memory 172 may be a computer-readable medium, a volatile memory unit(s), or non-volatile memory unit(s). The non-transitory memory 172 may be physical devices used to store programs (e.g., sequences of instructions) or data (e.g., program state information) on a temporary or permanent basis for use by the computing device 170. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 173 is capable of providing mass storage for the computing device 170. In some implementations, the storage device 173 is a computer-readable medium. In various different implementations, the storage device 173 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 172, the storage device 173, or memory on processor 171.

The high speed controller 174 manages bandwidth-intensive operations for the computing device 170, while the low speed controller 176 manages lower bandwidth-intensive operations. Such allocation of duties is exemplary only. In some implementations, the high-speed controller 174 is coupled to the memory 172, the display 179, which can be understood as display element 24, 124, 224; (e.g., through a graphics processor or accelerator), and to the high-speed expansion ports 175, which may accept various expansion cards (not shown). In some implementations, the low-speed controller 176 is coupled to the storage device 173 and a low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Also for purposes of this disclosure, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary.

Furthermore, to the extent that the terms “includes,” “has,” or “having” or variations in form thereof are used in either the detailed description or the claims, such terms are intended to be inclusive in a manner similar to the term “comprising” as “comprising” is interpreted when employed as a transitional word in a claim.

It is also to be understood that the specific devices and processes illustrated in the attached drawings and described in this specification are examples of aspects of the inventive concepts defined in the appended claims. Hence, specific dimensions and other physical characteristics relating to the examples disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An inductive cooktop system comprising:
a top plate comprising a top surface for supporting a cookware object;
a display disposed vertically below the top plate;
a sensor array disposed between the top plate and the display;
an induction coil disposed vertically below the display, wherein the induction coil is operable to generate a magnetic field extending above the top surface of the top plate; and
a control system in electronic communication with the display, the sensor array, and the induction coil, the control system configured to:
receive a cookware location input indicating a location of the cookware object on the top surface of the top plate;
determine a first set of pixels of the display corresponding to the indicated location from the cookware location input;
determine a second set of pixels of the display separate from the first set of pixels sized to display a control graphic;
generate a burner graphic at a periphery of the first set of pixels at the indicated location for the cookware object; and
generate a control graphic at the second set of pixels.

2. The induction cooktop system of claim 1, wherein at least one of the sensor array or the induction coil are used to provide the cookware location input.

3. The induction cooktop system of claim 1, wherein the sensor array is used to provide the cookware location input, and wherein the cookware location input comprises a cookware identification.

4. The induction cooktop system of claim 3, wherein the cookware identification comprises at least one of a cookware size based on the sensed periphery of the cookware object or an identifier based on a sensed bottom surface feature.

5. The induction cooktop system of claim 4, wherein the sensor array is configured receive touch inputs at the displayed control graphic.

6. The induction cooktop system of claim 5, wherein the displayed burner graphic extends a threshold distance outward from a sensed edge of the cookware object.

7. The induction cooktop system of claim 6, wherein the displayed control graphic is outside of the displayed burner graphic.

8. The induction cooktop system of claim 7, wherein the control system is configured to perform a graphic location process when multiple objects are placed on the top surface to display the burner graphic at sensed cookware objects and to display the control graphic at other locations on the display that are accessible to view and touch and free of objects placed on the top surface.

9. The inductive cooking system of claim 1, further comprising:
a cookware item adapted for inductively coupling with the electromagnetic field when disposed on the inductive cooktop; and
the inductive cooktop further comprising:
a first heat dissipation layer disposed between the top plate and the display;
a second heat dissipation layer disposed between the display and the induction coil.

10. The inductive cooking system of claim 9, wherein the cookware item comprises a ferrous metal base having a bottom surface, a plurality of pads disposed on the bottom surface, the plurality of pads creating an air gap between the bottom surface and the top surface when the cookware item is disposed on the top surface; and wherein the pads are adapted to be sensed by the sensor system.

11. The inductive cooking system of claim 10, wherein the plurality of pads are disposed in a pattern identifying one of a type of cookware item, a size of cookware item, or a combination of size and type of cookware item; and wherein the control system is operable to determine the type of cookware item, the size of cookware item, or the combination of size and type of cookware item based on the sensor array sensing the pattern.

12. The inductive cooking system of claim 11, wherein the control system is operable to determine an induction power parameter based on the determined type of cookware item, size of cookware item, or combination of size and type of cookware item.

13-15. (canceled)

16. The inductive cooktop of claim 1, wherein
the top plate is a removable top plate defining a cooktop surface.

17. The inductive cooktop of claim 1, wherein the sensor array comprises a weight sensor arranged to measure a weight of an object disposed on the top surface; the weight sensor in electronic communication with the control system, the control system operable to determine the weight of the object and to monitor a change in the weight over time.

18. An inductive cooktop for use in an inductive cooking system with a cookware item, the inductive cooktop comprising:
a removable top plate defining a cooktop surface;
a sealed display unit adapted to support the removable top plate, the sealed display unit comprising a sensor array, a transparent support plate disposed below the sensor array, a display element disposed below the transparent support plate, and a sealed heat dissipation layer extending between the transparent support plate and the display element; and
an electronics unit disposed below the sealed display unit, the electronics unit comprising an induction layer arranged to generate an electromagnetic field extending through the sealed display unit and above the removable top plate, and a control system in electronic communication with the sensor array, the display element, and the induction layer;
wherein the electronics unit is operable to generate user control functions displayed on the display element and to control the induction layer based on a user input sensed by the sensor array at the displayed user control function.

19. The inductive cooktop of claim 18, wherein the sealed display unit further comprises a heat exchanger arranged to remove heat from the sealed heat dissipation layer.

20. The inductive cooktop of claim 19, wherein the sealed heat dissipation layer comprises a circulating fluid having an optical index of refraction similar to the support plate and the top plate.

21-22. (canceled)

23. The inductive cooktop of claim 20, wherein the heat exchanger comprises one of an internal pump or internal fan for circulating the circulating fluid within the sealed heat dissipation layer.

24. The inductive cooktop system of claim 18, further comprising:
a control knob removably positionable on the cooktop surface, the control knob having a bottom surface and underside features disposed on the bottom surface, the sensor array operable to sense the underside features when the control knob is disposed on the cooktop surface.

25-26. (canceled)

27. The inductive cooking system of claim 24, wherein the control knob comprises a top portion and a bottom portion, the top on being movable relative to the bottom portion, and wherein the bottom surface comprises a first outer region associated with the bottom portion, and a second inner region associated with the top portion; the plurality of pads comprising a first set of pads disposed in the first outer region and a second set of pads disposed on the second inner region.

28-37. (canceled)
